(19) United States
(12) Patent Application Publication
(10) Pub. No.: US 2018/0178619 A1
(43) Pub. Date: Jun. 28, 2018

(54) AIRFLOW CONTROL SYSTEM OF A WORK VEHICLE

(71) Applicant: CNH Industrial America LLC, New Holland, PA (US)

(72) Inventor: Joaquim Guitart Corominas, Barcelona (ES)

(73) Assignee: CNH Industrial America LLC

(21) Appl. No.: 15/391,518

(22) Filed: Dec. 27, 2016

(51) Int. Cl. B60H 1/00; B60H 1/24; B60H 3/06

(52) U.S. Cl. CPC B60H 1/00378; B60H 1/00735; B60H 2003/0683; B60H 1/24; B60H 3/06; B60H 1/00978

(57) ABSTRACT

A controller of an airflow control system is configured to instruct a blower to output an airflow, to instruct an airflow control assembly to close a door upon detection of a first threshold pressure within the interior of the cab, and to measure a depressurization time between the detection of the first threshold pressure and detection of a second threshold pressure, less than the first threshold pressure, which is used to determine a restriction factor. The controller is configured to determine an airflow rate into the interior of the cab based at least in part on the restriction factor and a pressure within the interior of the cab. The controller is further configured to instruct the blower to adjust the airflow, instruct the airflow control assembly to adjust a position of the door, or a combination thereof based at least in part on the airflow rate.

### BACKGROUND

The present disclosure relates generally to an airflow control system of a work vehicle.

Certain work vehicles (e.g., tractors, harvesters, skid steers, etc.) include a heating, ventilation, and air condition (HVAC) system configured to control an airflow into a cab of the work vehicle. In addition, the HVAC system is configured to pressurize the cab to substantially reduce ingress of dirt and/or other contaminants, to enhance passenger comfort, to reduce noise, or a combination thereof. To keep the cab at a target pressure, air from an external environment cab is drawn into the HVAC system through a filter. When the filter is clogged, a higher voltage may be supplied to a blower to establish the target pressure within the cab. Additionally, air exits the cab over time through seals around doors, windows, and other components of the cab. The efficiency of the seals may decrease over time (e.g. the seals may deteriorate and/or become ineffective), leading to increased air exiting the cab. Operating the blower to achieve the target pressure while the filter is clogged and/or while the seals of the cabin are leaking reduces the efficiency of the HVAC system.

### BRIEF DESCRIPTION

In one embodiment, an airflow control system of a work vehicle includes a controller having a memory and a processor. During an initialization phase, the controller is configured to instruct an airflow control assembly to transition a door of the airflow control assembly to an open position. The airflow control assembly is configured to direct an airflow from an external environment into an interior of a cab of the work vehicle while the door is in the open position and to recirculate the airflow to the interior of the cab while the door is in a closed position. During the initialization phase, the controller is also configured to instruct a blower to output the airflow and to instruct the airflow control assembly to close the door upon detection of a first threshold pressure within the interior of the cab. During the initialization phase, the controller is further configured to measure a depressurization time between the detection of the first threshold pressure and detection of a second threshold pressure, less than the first threshold pressure. In addition, during the initialization phase, the controller is configured to determine a restriction factor based at least in part on the depressurization time. During an operation phase, the controller is configured to determine an airflow rate into the interior of the cab based at least in part on the restriction factor and a pressure within the interior of the cab. During the operation phase, the controller is further configured to instruct the blower to adjust the airflow, instruct the airflow control assembly to adjust a position of the door, or a combination thereof based at least in part on the airflow rate.

In another embodiment, an airflow control system of a work vehicle includes a controller having a memory and a processor. During an initialization phase, the controller is configured to instruct an airflow control assembly to transition a door of the airflow control assembly to an open position. The airflow control assembly is configured to direct an airflow from an external environment into an interior of a cab of the work vehicle while the door is in the open position and to recirculate the airflow to the interior of the cab while the door is in the closed position. During the initialization phase, the controller is also configured to instruct a blower to output the airflow and to instruct the airflow control assembly to close the door upon detection of a first threshold pressure. During the initialization phase, the controller is further configured to measure a depressurization time between the detection of the first threshold pressure and a detection of a second threshold pressure, less than the first threshold pressure. In addition, during the initialization phase, the controller is configured to determine a restriction factor based at least in part on the depressurization time. During an operation phase, the controller is configured to output a first signal to the blower to instruct the blower to adjust the airflow. During the operation phase, the controller is also configured to identify a clogged filter of the airflow control assembly based at least in part on the first signal, a target airflow rate, and the restriction factor. Further, during the operation phase and upon detection of the clogged filter, the controller is configured to output a second signal to a user interface indicative of instructions to inform an operator that the clogged filter is detected.

In a further embodiment, a method for controlling an airflow through an interior of a cab of a work vehicle includes instructing, via a controller, an airflow control assembly to transition a door of the airflow control assembly to an open position. The airflow control assembly is configured to direct an airflow from an external environment into an interior of a cab of the work vehicle while the door is in the open position and to recirculate the airflow to the interior of the cab while the door is in the closed position during an initialization phase. The method also includes instructing, via the controller, a blower to output the airflow during the initialization phase and instructing, via the controller, the airflow control assembly to close the door upon detection of a first threshold pressure during the initialization phase. Further, the method includes measuring, via the controller, a depressurization time between the detection of the first threshold pressure and a detection of a second threshold pressure, less than the first threshold pressure during the initialization phase. Additionally, the method includes determining, via the controller, a restriction factor based at least in part on the depressurization time during the initialization phase. Also, the method includes determining, via the controller, an airflow rate into the interior of the cab based at least in part on the restriction factor and a pressure within the interior of the cab during an operation phase. Further, the method includes instructing, via the controller, the blower to adjust the airflow, instructing the airflow control assembly to adjust a position of the door, or a combination thereof, based at least in part on the airflow rate during the operation phase.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may include an airflow control system;

FIG. 2 is a schematic diagram of an embodiment of an HVAC system that may be employed within the work vehicle of FIG. 1;

FIG. 3 is a flow diagram of an embodiment of a method for performing an initialization phase to determine a restriction factor of a cab of the work vehicle;

FIG. 4 is a graph of an embodiment of a cab pressure curve measured during the initialization phase of FIG. 3; and

FIG. 5 is a flow diagram of an embodiment of a method for performing an operation phase utilizing the restriction factor.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The embodiments disclosed herein relate generally to an airflow control system for a work vehicle. Additionally, the embodiments disclosed herein relate to methods for controlling various components of an HVAC system to determine a restriction factor related to a sealing quality of a cab of the work vehicle. Further, the embodiments disclosed herein relate to using the restriction factor to operate the HVAC system more efficiently. The restriction factor of the cab relates to how well the cab retains pressure. A pressurized cab is desired so that air from the external environment does not enter the cab through gaps and/or openings in the cab and/or in the seals surrounding any doors and/or windows of the cab. Instead, air flows into the cab through a filter. The filter is configured to block at least a portion of certain contaminants (e.g., dust, fertilizer, etc.) from entering the cab. The contaminants collect on the filter, creating a pressure drop in incoming air so more energy may be used to draw the incoming air into the cab. After the filter is clogged, it may be cleaned or replaced. Additionally, the sealing of the cab may become less effective (e.g., deteriorate) over time, thereby lowering the restriction factor. As the effectiveness of the seals is reduced, air from inside the cab may leak to the external environment, and energy may be expended to return the cab to the target pressure. Accordingly, flowing air through a clogged filter and/or allowing air to escape through ineffective seals wastes energy by powering the blower more often and thus reduces the efficiency of the HVAC system.

During an initialization phase, a controller instructs a blower to pressurize the cab to a first threshold pressure and close a door of the airflow control assembly. Air then leaks through the seals until the cab depressurizes to a lower, second threshold pressure. The depressurization time (e.g., the time the cab takes to depressurize from the first threshold pressure to the second threshold pressure) is compared to a restriction factor relationship stored in a memory of the controller. With the restriction factor relationship, the controller determines the restriction factor of the cab based at least in part on the depressurization time. If the restriction factor is not within a desired range, the controller may identify ineffective seals. The restriction factor may be either above or below the desired range. Further, during an operation phase of the cab, the controller determines an airflow rate into an interior of the cab based at least in part on the restriction factor and a pressure within the interior of the cab. The controller then instructs the blower to adjust the airflow, instructs the airflow control assembly to adjust a positon of a door of the airflow control assembly, or a combination thereof based at least in part on the airflow rate. If the airflow does not adjust the airflow rate to within a threshold range of the target airflow rate, the controller may also identify if the filter is clogged (i.e., identify a clogged filter). Accordingly, the disclosed embodiments provide systems and methods to determine the airflow rate into the cab without the added expense of airflow sensors (e.g., mass airflow sensor, volumetric airflow sensor), identify ineffective seals of the cab, and/or identify clogged filters.

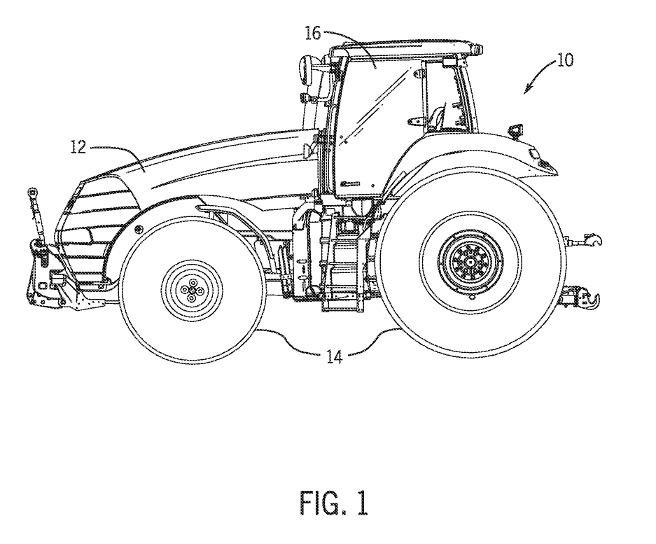

Turning now to the drawings, FIG. 1 is a side view of an embodiment of a work vehicle 10 that may include an airflow control system. In the illustrated embodiment, the work vehicle 10 includes a body 12 configured to house an engine, a transmission, other systems of the work vehicle 10, or a combination thereof. In addition, the work vehicle 10 includes wheels 14 configured to be driven by the engine and transmission, thereby driving the work vehicle 10 along a field, a road, or any other suitable surface. In the illustrated embodiment, the work vehicle 10 includes a cab 16 configured to house an operator. As discussed in detail below, the work vehicle may include a heating, ventilation, and air conditioning (HVAC) system configured to control an air temperature within the cab and/or to pressurize the cab. Pressurizing the cab may substantially reduce ingress of dirt and/or other contaminants, enhance passenger comfort, reduce noise, or a combination thereof. In certain embodiments, the HVAC system includes an airflow control system configured to control an airflow output from a blower and/or control a position of a door of an airflow control assembly, thereby maintaining a target airflow into the cab. While the illustrated work vehicle 10 is a tractor, it should be appreciated that the airflow control system described herein may be employed within any suitable work vehicle, such as a harvester, a sprayer, or a skid steer.

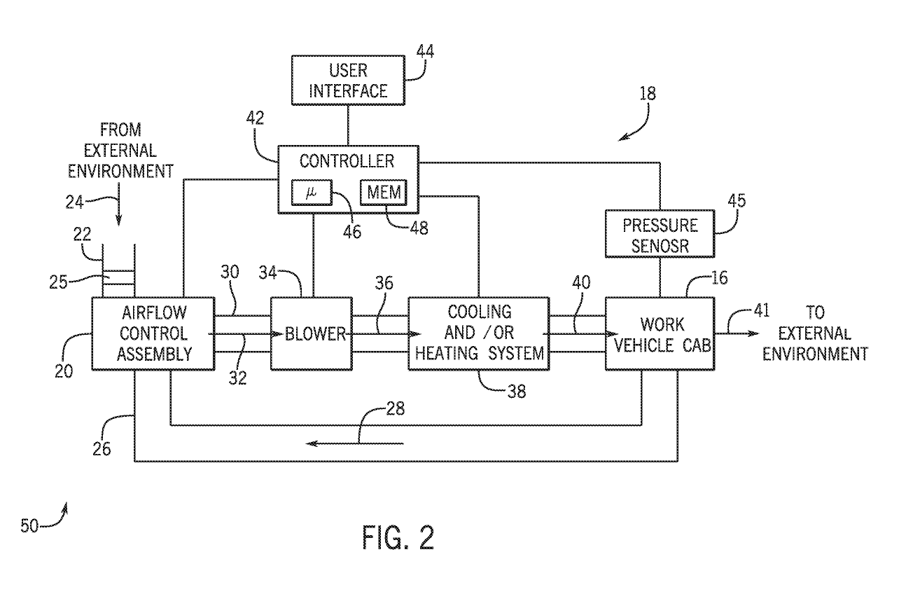

FIG. 2 is a schematic diagram of an embodiment of an HVAC system 18 that may be employed within the work vehicle 10 of FIG. 1. In the illustrated embodiment, the HVAC system 18 includes a blower 34, a cooling and/or heating system 38, and an airflow control system 50. In the current embodiment, the airflow control system 50 includes an airflow control assembly 20 configured to control mixing of air from an environment external to the cab with air recirculated from the cab. The airflow control assembly 20 includes a body having a first inlet 22 configured to receive a first airflow 24 from the environment external to the cab 16, and a second inlet 26 configured to receive a second airflow 28 from an interior of the cab 16. The body of the airflow control assembly 20 also includes an outlet 30 configured to output a third airflow 32 to the interior of the cab 16.

In certain embodiments, the airflow control assembly 20 includes a door disposed within the body and configured to rotate relative to the body to control the first airflow through the first inlet and the second airflow through the second inlet, thereby mixing the external air with the recirculated air. The door may be moved between an open position and a closed position. In the open position, external air enters the airflow control assembly 20 through the first inlet 22, and the door blocks airflow through the second inlet 26. In the closed position, the door blocks airflow through the first inlet 22, and recirculated air enters the airflow control assembly 20 through the second inlet 26. In an intermediate position between the open position and the closed position (e.g., a partly-open position), external air and recirculated air enter the airflow control assembly 20. In certain embodiments, many intermediate positions exist and varying the position of the door varies the ratio of external air and recirculated air that enter the airflow control assembly 20. In certain embodiments, the door may be controlled such that a desired amount of fresh air may be permitted to enter to airflow control assembly 20 through the first inlet 22 to keep the cab 16 pressurized.

In the illustrated embodiment, the airflow control system 50 includes a filter 25 that filters contaminants (e.g., dust fertilizer, etc.) from the first airflow 24. The filter 25 collects contaminants that would otherwise flow into the cab 16 of the work vehicle. In certain embodiments, the filter 25 includes a range of internal components for capturing and/or blocking particulate matter and debris and/or for filtering finer matter such as dust from the air, while permitting air to flow through the first inlet 22 to the airflow control assembly 20. The contaminants may collect on a surface and/or in an interior of the filter 25 and clog the filter over time. With a clogged filter, the HVAC system 18 may use more energy to draw the air into the cab, as compared to a clean filter 25. Once clogged, the filter can be cleaned or replaced to reduce the energy utilized by the HVAC system 18 to draw air into the cab 16. In other embodiments, the cab 16 may operate without a filter 25 and the disclosed embodiments may be used to identify ineffective seals and/or restriction factors instead of clogged filters.

In the illustrated embodiment, the HVAC system 18 includes the blower 34 configured to receive the third airflow 32 from the airflow control assembly 20 and to establish a fourth airflow 36 based on a capacity of the blower 34. In certain embodiments, there may be more than one blower 34 in the HVAC system 18 (e.g., a blower for recirculating airflow, a blower for fresh airflow, among others). In addition, a cooling and/or heating system 38 is configured to receive the fourth airflow 36 and to output a fifth airflow 40 having a higher or lower temperature than the fourth airflow 36. As illustrated, the fifth airflow 40 flows into the cab 16 of the work vehicle. During certain operating conditions, the cooling and/or heating system 38 may be deactivated. As a result, the temperature of the fifth airflow 40 may be substantially equal to the fourth airflow 36. The heating and/or cooling system 38 may include a heater core of a heating system and/or an evaporator of a refrigeration system, among other heating and/or cooling devices/systems. In certain embodiments, the cooling and/or heating system may be omitted, and the fourth airflow may flow directly into the cab 16.

In the illustrated embodiment, the HVAC system 18 (e.g., the airflow control system 50 of the HVAC system 18) includes a controller 42 communicatively coupled to the airflow control assembly 20, the blower 34, and the cooling and/or heating system 38. The controller 42 may be configured to instruct an actuator of the airflow control assembly to control a position of the door, thereby controlling the mixing of the external air with the recirculated air. In addition, the controller 42 may be configured to control an output (e.g., capacity, voltage) of the blower 34, thereby controlling the flowrate of the airflow to the cab 16. As discussed herein, reference to adjustments to the capacities of the blower 34 relates to adjustments to the airflow output by the blower. In some embodiments, the capacities of the blower 34 may be adjusted by multiple methods, including but not limited to: adjusting the voltage input to the blower 34, adjusting the angles of blades that may be disposed inside the blower 34, or any other suitable adjustment to the blower 34 that adjusts the output of the blower 34. In embodiments with more than one blower, the controller 42 may be configured to modify the capacity of each blower. The controller 42 may also be configured to control the cooling and/or heating system 38 to control the temperature of the fifth airflow 40 to the cab.

In the illustrated embodiment, the controller 42 is communicatively coupled to a user interface 44. The user interface 44 may be located within the cab of the work vehicle and configured to receive input from the operator, such as input for controlling the airflow control assembly 20, the blower 34, the cooling and/or heating system 38, or a combination thereof. In the illustrated embodiment, the user interface 44 is also configured to display alerts and/or informative notices related to the condition(s) of component(s) of the work vehicle. In certain embodiments, the alerts and/or informative notices may also be emitted as audio messages. The alerts and/or informative notices may include notices about the state of the filter 25, the speed of the work vehicle, the temperature of the cab 16, the temperature of the environment external to the cab 16, the pressure of oil inside the engine, and/or any other notices useful to the operator.

In the illustrated embodiment, the airflow control system 50 also includes a pressure sensor 45 communicatively coupled to the controller 42. The pressure sensor 45 is fluidly coupled to an interior of the cab 16 and configured to output a signal indicative of the pressure within the interior of the cab 16. The pressure sensor 45 sends the signal indicative of pressure to the controller 42. In certain embodiments, the pressure sensor 45 may be omitted. In further embodiments, the airflow control system 50 may include additional pressure sensor(s) communicatively coupled to other portions of the HVAC system 18, such as the air control assembly 20 and/or the blower 34.

In certain embodiments, the controller 42 is an electronic controller having electrical circuitry configured to process data from certain components of the HVAC system 18, such as the user interface 44. In the illustrated embodiment, the controller 42 includes a processor, such as the illustrated microprocessor 46, and a memory device 48. The controller 42 may also include one or more storage devices and/or other suitable components. The processor 46 may be used to execute software, such as software for controlling the HVAC system 18, and so forth. Moreover, the processor 46 may include multiple microprocessors, one or more “general-purpose” microprocessors, one or more special-purpose microprocessors, and/or one or more application specific integrated circuits (ASICS), or some combination thereof. For example, the processor 46 may include one or more reduced instruction set (RISC) processors.

The memory device 48 may include a volatile memory, such as random access memory (RAM), and/or a nonvolatile memory, such as read-only memory (ROM). The memory device 48 may store a variety of information and may be used for various purposes. For example, the memory device 48 may store processor-executable instructions (e.g., firmware or software) for the processor 46 to execute, such as instructions for controlling the HVAC system 18, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the HVAC, etc.), and any other suitable data.

The controller 42 is configured to determine a restriction factor indicative of a sealing quality of the cab 16. The restriction factor quantifies the quality of the air sealing of the cab. In certain embodiments, the quality of the air sealing is based at least in part on the seals between the body of the cab 16 and other components of the cab, such as windows, doors, and inlets, among others. It is desirable to have a restriction factor within a target range that corresponds to a desired sealing of the cab 16. For example, if the restriction factor is lower than the target restriction factor, the leak airflow 41, which exits the cab 16 and rejoins the external environment, may be greater than desired. Therefore, more energy may be expended to power the blower 34 and pressurize the cab with air from the external environment. In addition, if the restriction factor is greater than the target range, a target airflow through the cab 16 may not be achieved. Accordingly, the controller 42 may identify ineffective seals of the cab 16 that correspond to restriction factors that are not within the target range. The controller 42 may additionally output a signal to recommend the seals of the cab 16 be adjusted.

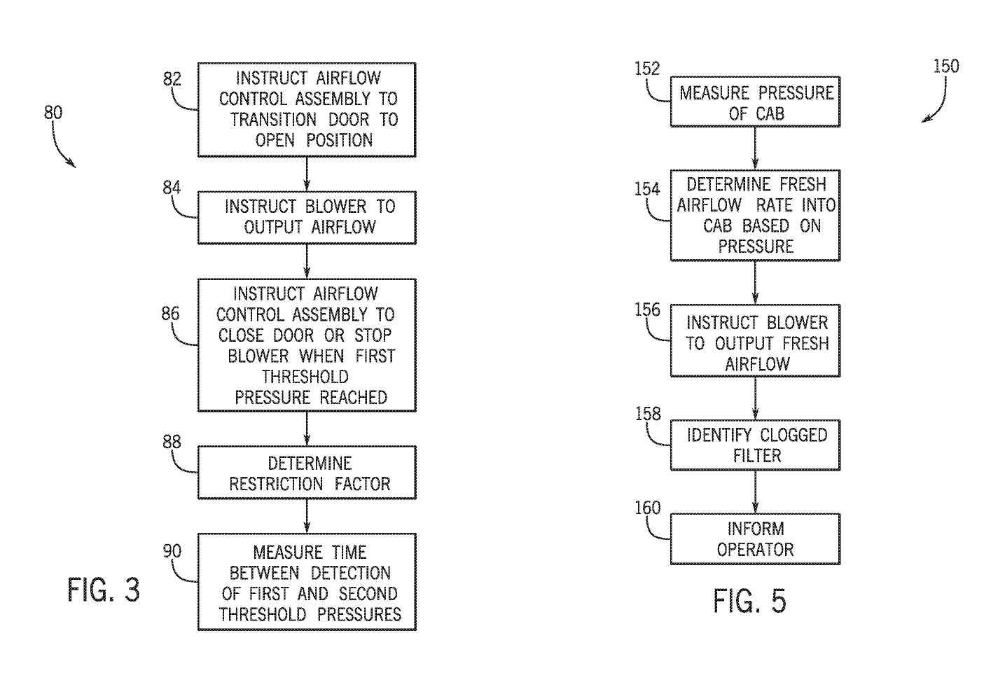

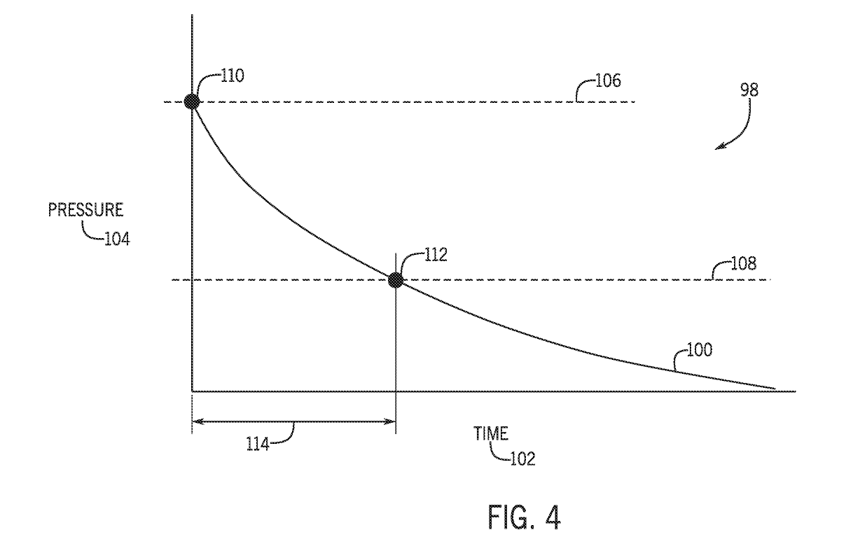

In the current embodiment, the controller 42 is configured to determine the restriction factor of the cab. The controller 42 operates in at least two phases: an initialization phase to determine the restriction factor and an operation phase to use the restriction factor to control the blower 34 and/or the airflow control assembly 20 based at least in part on the restriction factor. In certain embodiments, the controller 42 operates in further phases such as a cool down phase, a warm up phase, an energy conservation phase, among others. In certain embodiments, the controller 42 is additionally configured to identify when the filter 25 is clogged (e.g., identify a clogged filter) based on the restriction factor. Generally, the controller 42 identifies the clogged filter by determining a target airflow rate for operation of the blower 34 based on the restriction factor, instructing the blower to operate at the target airflow rate, and comparing the expected airflow from the blower 34 to the actual airflow from the blower. In certain embodiments, the controller 42 is further configured to identify ineffective seals of the cab 16. Generally, the controller 42 identifies the ineffective seals by determining whether the restriction factor of the cab is within a desired range. Determination of the restriction factor, identification of the clogged filter, and identification of the ineffective seals are described in more detail below with regards to FIGS. 3 and 4 respectively.

FIG. 3 is a flow diagram of an embodiment of a method 80 for performing an initialization phase to determine a restriction factor of the cab 16. In certain embodiments, the method 80 is performed by the controller of the airflow control system of the work vehicle. As shown, the method 80 begins with instructing (block 82) the airflow control assembly to transition the door to an open position. In certain embodiments, when the door is in the open position, 100 percent fresh air flows into the cab, and when a door is in the closed position, 100 percent recirculated air flows into the cab. When the door is in an intermediate position, (e.g., a positon in between the open position and the closed position), a mixture of fresh air and recirculated air related to the position of the door flows into the cab. For example, when the door is in a position closer to the open position than the closed position, a greater amount of fresh air than recirculated air may flow into the cab. Adding fresh air, or air from the external environment, increases the pressure within the cab, whereas recirculating air to the cab does not increase the pressure within the cab. The method 80 also includes instructing (block 84) the blower to output a target (e.g. specified, requested, calculated) airflow to the cab. With the door in the open position, the airflow from the blower includes only fresh air or mostly fresh air, which pressurizes the cab.

The method 80 further includes instructing (block 86) the airflow control assembly to stop adding fresh air to the cab when a first threshold pressure is reached inside the cab. The first threshold pressure may be 20 pascals, 50 pascals, 100 pascals, 120 pascals, 150 pascals, 200 pascals, or any other suitable pressure based on operating conditions. Moreover, in certain embodiments, the first threshold pressure may be between 20 pascals and 200 pascals, between 50 pascals and 150 pascals, between 100 and 120 pascals, or any other suitable range based on operating conditions. The flow of fresh air to the cab may be stopped by either moving the door to the closed position or by instructing the blower to stop blowing. When the door is closed, the airflow control assembly recirculates air from the cab to establish a target total airflow rate (e.g., a target total airflow rate from the blower). If the target total airflow rate is zero, the flow of fresh air to the cab may also be stopped by instructing the blower to stop blowing, without repositioning the door. The blower may then stop blowing any air into the cab, so the fresh airflow may be zero.

In the current embodiment, the method 80 also includes measuring (block 88) the depressurization time (e.g., the amount of time that passes until the cab depressurizes to a second threshold pressure, less than the first threshold pressure). The leak airflow exits the cab through cracks and imperfections in the air sealing of the cab, thus enabling the cab to depressurize over time. In certain embodiments, the second threshold pressure may be 5 pascals, 20 pascals, 50 pascals 100 pascals, 120 pascals, 150 pascals, or any other suitable pressure based on operating conditions, lower than the first threshold pressure. Moreover, in certain embodiments, the second threshold pressure may be between 5 pascals and 150 pascals, between 20 pascals and 120 pascals, between 100 and 120 pascals, or any other suitable range based on operating conditions.

Once the depressurization time is calculated, the restriction factor is determined (block 90). In certain embodiments, the depressurization time is compared to a relationship between depressurization time and restriction factor (e.g., which is determined from cabs of work vehicles via bench tests). For example, the bench test(s) may involve work vehicles which are kept at a factory, a laboratory, or a similar location for testing. Cabs with various restriction factors may be pressurized to the first threshold pressure, and the depressurization times at which the cabs reach the second threshold pressure is recorded. Subsequently, a restriction factor curve relating restriction factor to depressurization time is generated and is used to develop a restriction factor relationship that relates depressurization time to restriction factor. The controller uses the restriction factor relationship and the depressurization time for the cab to determine the corresponding restriction factor for the cab. Restriction factor relationships may be determined for each model, type, or manufacturer of cabs of work vehicles. In certain embodiments, the restriction factor relationship is theoretically determined instead of experimentally determined. In other embodiments, the restriction factor relationship is extrapolated and/or interpolated from a number of experiments to cover the entire range of possible restriction factors. In further embodiments, the restriction factor relationship is embodied as an equation, which is used to calculate the restriction factor for a depressurization time, embodied as a lookup chart, or both. For example, a restriction factor relationship may generally specify that higher depressurization times correspond to lower restriction factors. Another restriction factor relationship may generally specify that restriction factors for cabs are proportional to the square of the depressurization time. Additional restriction factor relationships may provide relationships based on the specific configurations specific to a cab.

In certain embodiments, the initialization phase of method 80 is performed each time that all windows or doors of the work vehicle are closed. In other embodiments, the initialization phase of method 80 is performed when all windows of the cab and doors of the cab are closed and an initialization delay (e.g. a time since the last initialization phase was performed) has elapsed. The initialization delay may be, for example, 1 calendar day, 30 calendar days, 60 calendar days, or 120 calendar days, or any other suitable quantity of calendar days based on initialization requirements of the cab. Moreover, in certain embodiments, the initialization delay may be between 1 calendar day and 120 calendar days, between 30 calendar days and 60 calendar days, or any other suitable range of calendar days based on initialization requirements of the cab. In other embodiments, the initialization delay may be a number of hours the work vehicle has operated, for example, 20 operational hours, 50 operational hours, 100 operational hours, 200 operational hours, or any other quantity of operational hours based on initialization requirements of the cab. Furthermore, in other embodiments, the initialization delay may be between 20 operational hours and 200 operational hours, between 50 operational hours and 100 operational hours, or any other suitable range of operational hours based on initialization requirements of the cab. In further embodiments, the initialization delay is set by the operator of the work vehicle or by a manufacturer and may be changed to a different initialization delay, or the initialization phase may be completed upon a request made by the operator.

FIG. 4 is a graph 98 of an embodiment of a cab pressure curve 100 representing a restriction factor relationship determined during an initialization phase of FIG. 3. The graph 98 illustrates the relationship between pressure within the cab 16 and time during the initialization phase, and is used to calculate a depressurization time 114. As illustrated, a horizontal axis 102 represents time and a vertical axis 104 represents the pressure within the cab 16. In the current embodiment, a horizontal first line 106 represents the first threshold pressure, which is constant with respect to time. A horizontal second line 108 represents the second threshold pressure, which is lower than the first threshold pressure and also constant with respect to time. In certain embodiments, the cab 16 is pressurized to the first threshold pressure, as represented by the first line 106. Then, as shown by the curve 100, the pressure within the cab descends from the first threshold pressure to the second threshold pressure, as represented by the second line 108. As illustrated, the curve 100 begins at a first intersection point 110 where the curve 100 and the first line 106 intersect. The pressure within the cab 16 then descends until the curve 100 intersects the second line 108 at the second intersection point 112. The length of time for the pressure within the cab 16 to drop from the first intersection point 110 to the second intersection point 112, as taken along the horizontal axis 102, is equal to the depressurization time 114 of the cab 16. In the depicted embodiment, the pressure of the cab 16 continues to descend after the depressurization time 114 is determined. In other embodiments, the controller 42 may instruct the airflow control assembly 20 to increase the pressure of the cab 16 to an operational pressure immediately after the depressurization time 114 is determined so that the target pressure of the cab 16 is achieved.

As previously described, the depressurization time 114 is used to determine the restriction factor. In certain embodiments, the depressurization time 114 is compared to a restriction factor relationship. The restriction factor relationship relates the depressurization time to a restriction factor. If the restriction factor is not within the target range, the controller may identify that the seals of the cab are ineffective (e.g., too effective or not effective enough). Further, if the initialization phase occurs while doors and/or the windows of the cab are open (e.g., intentionally, unintentionally), the controller may identify that the doors and/or the windows of the cab are open. The restriction factor is utilized during the operation phase as described below.

FIG. 5 is a flow diagram of an embodiment of a method 150 for performing an operation phase utilizing the determined restriction factor. In certain embodiments, the method 150 is performed by the controller of the work vehicle. As shown, the method 150 begins with measuring (block 152) the pressure of the cab. The pressure sensor may measure the pressure of the cab during and/or before and/or after identifying a clogged filter. In certain embodiments, the pressure sensor sends a signal to the controller indicative of the pressure of the cab. Accordingly, the controller may compare the signal to a target pressure of the cab and adjust operations (e.g., blower capacity, door position, etc.) in order to achieve the target pressure.

The method 150 includes determining (block 154) the fresh airflow rate into the cab based at least in part on the pressure of the cab. In certain embodiments, the fresh airflow rate is the determined and/or target rate of fresh airflow the blower outputs into the cab that pressurizes the cab. In some embodiments, the determined and/or target rate of fresh airflow is output by more than one blower and/or the door of the airflow control assembly. Additionally, in some embodiments, the controller determines the fresh airflow rate based at least in part on the restriction factor and the target pressure within the cab, then instructs the blower to adjust the fresh airflow to the cab and/or the door of the airflow control assembly to adjust. In certain embodiments, the target pressure may be 5 pascals, 20 pascals, 50 pascals, 60 pascals, 100 pascals, 120 pascals, or any other suitable pressure based on operating conditions. Moreover, in certain embodiments, the target pressure may be between 5 pascals and 120 pascals, between 20 pascals and 100 pascals, between 60 and 100 pascals, or any other suitable range based on operating conditions. In particular, the controller may use the restriction factor to estimate and/or quantify the leak airflow. There is a relationship between these factors, such as, for example, the pressurization of the cab is proportional to the restriction factor multiplied by the square of the airflow. In certain embodiments, the controller is configured to use the relationship and/or other suitable relationships to correlate airflow rates, restriction factors, and pressures.

The method 150 includes instructing (block 156) the blower (e.g., one or more blowers) to output the fresh airflow. The method 150 may additionally include instructing the door of the airflow control assembly to move in order for the HVAC system to output the fresh airflow. Based on the estimation of the leak airflow, the controller may also calculate a target fresh airflow rate to create the fresh airflow into the cab and/or the target pressure of the cab. More particularly, the controller outputs a first signal indicative of an optimal blower speed (e.g., capacity) for the blower. In this manner, the controller may instruct the blower to adjust the fresh airflow. In some embodiments, the controller may also instruct the airflow control assembly to move the door to a target position. If the blower operates at the expected capacity (e.g., voltage) and the fresh airflow rate into the cab and/or the target pressure of the cab is not reached, the controller instructs the blower to operate at a higher capacity and/or instructs the door of the airflow control assembly to open further. The controller increments the capacity of the blower until the fresh airflow into the cab and/or the target pressure of the cab is achieved or the blower is operating at a maximum capacity (e.g., maximum voltage). Eventually, if the filter is not too clogged, an actual (e.g. output) capacity of the blower will generate the fresh airflow rate required to pressurize the cab to the target pressure. If the capacity of the blower has been incremented to the maximum capacity and/or the door of the airflow control assembly is fully open, and the fresh airflow is not achieved, the filter may be identified as clogged and the filter may be cleaned or replaced before the target pressure of the cab may be achieved.

The method 150 also includes identifying (block 158) a clogged filter. In some embodiments, the controller identifies the clogged filter based at least in part on the first signal. In particular, by comparing the output capacity of the blower (e.g., blowers) and the position of the door that achieves the fresh airflow and/or the target pressure of the cab to the expected capacity of the blower, the controller may determine the state of the filter. In some embodiments, the controller may determine the state of the filter by comparing the capacity of the blower and/or position of the door that achieve the target pressure of the cab to a look up table that relates the capacity and position of the door to a given filter state. Accordingly, a relationship exists between the state of the filter and the output capacity of the blower and/or position of the door. For example, if the output capacity of the blower is higher than the expected capacity by a threshold, the controller may determine that the filter is clogged. In another example, if the output capacity of the blower is at a maximum and/or the door is in the fully open position, the controller may determine that the filter is clogged. As discussed above, when the filter is clogged, the blower expends an undesired amount of energy to draw air from the external environment through the clogged filter. Use of the restriction factor enables the controller to determine the expected capacity of the blower, which is compared to the output capacity of the blower, thereby facilitating determination of the state of the filter. Additionally, the controller may identify the clogged filter if the blower is operating at the maximum capacity but the fresh airflow or the target pressurization of the cab is not achieved.

In certain embodiments, the controller may operate by comparing capacities and/or signals other than voltages. For example, the controller may compare hydraulic signals, pneumatic signals, electrical signals, or any combination thereof.

The method 150 further includes informing (block 160) the operator of the determination of block 156. In certain embodiments, the user interface may display a message and/or emit an audio message informing the operator that the filter is clogged and/or that the filter is clogged at a certain percent. In certain embodiments, the user interface may inform the operator that the filter is 10 percent clogged, 50 percent clogged, 70 percent clogged, 100 percent clogged or any other suitable percent clogged related to the state of the filter. Moreover, in certain embodiments, the user interface may inform the operator that the filter is between 10 and 100 percent clogged, between 50 and 70 percent clogged, or any other suitable range of percent clogged related to the state of the filter. The message is displayed whenever the controller determines the filter is clogged beyond the threshold and/or whenever ineffective seals of the cab are identified. The message may be repeated at various times suitable for alerting the operator that the filter is clogged or the seals are ineffective. Therefore, the operator can clean or replace the filter and/or adjust or replace the seals to optimize operation of the HVAC system.

While only certain features have been illustrated and described herein, many modifications and changes will occur to those skilled in the art. It is, therefore, to be understood that the appended claims are intended to cover all such modifications and changes as fall within the true spirit of the disclosure.

1. An airflow control system of a work vehicle, comprising:
a controller having a memory and a processor, wherein during an initialization phase, the controller is configured to:
instruct an airflow control assembly to transition a door of the airflow control assembly to an open position, wherein the airflow control assembly is configured to direct an airflow from an external environment into an interior of a cab of the work vehicle while the door is in the open position and to recirculate the airflow to the interior of the cab while the door is in a closed position;
instruct a blower to output the airflow;
instruct the airflow control assembly to close the door or stop the blower upon detection of a first threshold pressure within the interior of the cab;
measure a depressurization time between the detection of the first threshold pressure and detection of a second threshold pressure within the interior of the cab, less than the first threshold pressure; and
determine a restriction factor based at least in part on the depressurization time;
wherein during an operation phase, the controller is configured to:
determine an airflow rate into the interior of the cab based at least in part on the restriction factor and a pressure within the interior of the cab; and
instruct the blower to adjust the airflow, instruct the airflow control assembly to adjust a position of the door, or a combination thereof based at least in part on the airflow rate.

2. The airflow control system of claim 1, comprising a pressure sensor configured to fluidly couple to the interior of the cab and to output a signal indicative of the pressure within the interior of the cab.

3. The airflow control system of claim 1, wherein during the operation phase, the controller is configured to instruct the blower to adjust the airflow until the airflow rate is within a threshold range of a target airflow rate.

4. The airflow control system of claim 3, wherein the controller is configured to output a first signal to the blower to instruct the blower to adjust the airflow, wherein the first signal is indicative of an optimal speed of the blower.

5. The airflow control system of claim 4, wherein the controller is configured to identify a clogged filter based at least in part on the first signal, the target airflow rate, and the restriction factor, and the controller is configured to output a second signal.

6. The airflow control system of claim 5, wherein the first signal is indicative of an output voltage to the blower, the controller is configured to compare the output voltage to an expected voltage for the target airflow rate, and the controller is configured to identify the clogged filter based at least in part on the comparison.

7. The airflow control system of claim 1, wherein the controller is configured to automatically initiate the initialization phase while doors of the cab and windows of the cab are closed and an initialization delay has elapsed.

8. The airflow control system of claim 8, wherein the airflow control system does not include an air flow sensor.

9. An airflow control system of a work vehicle, comprising:
a controller having a memory and a processor, wherein during an initialization phase, the controller is configured to:
instruct an airflow control assembly to transition a door of the airflow control assembly to an open position, wherein the airflow control assembly is configured to direct an airflow from an external environment into an interior of a cab of the work vehicle while the door is in the open position and to recirculate the airflow to the interior of the cab while the door is in a closed position;
instruct a blower to output the airflow;
instruct the airflow control assembly to close the door or stop the blower upon detection of a first threshold pressure within the interior of the cab;
measure a depressurization time between the detection of the first threshold pressure and detection of a second threshold pressure within the interior of the cab, less than the first threshold pressure; and
determine a restriction factor based at least in part on the depressurization time;
wherein during an operation phase, the controller is configured to:
output a first signal to the blower to instruct the blower to adjust the airflow;
identify a clogged filter of the airflow control assembly based at least in part on the first signal, a target airflow rate, and the restriction factor; and
upon identification of the clogged filter, output a second signal to a user interface indicative of instructions to inform an operator that the clogged filter is detected.

10. The airflow control system of claim 9, wherein the controller is configured to determine the restriction factor is based at least in part on a curve of the depressurization time versus the restriction factor stored within the memory.

11. The airflow control system of claim 9, wherein the controller is configured to increment the first signal until the blower outputs a target airflow.

12. The airflow control system of claim 9, wherein the controller is configured to automatically initiate the initialization phase while doors of the cab and windows of the cab are closed and an initialization delay has elapsed.

13. The airflow control system of claim 9, wherein the controller is configured to identify a clogged filter based at least in part on the first signal, the target airflow rate, and the restriction factor.

14. The airflow control system of claim 9, wherein the controller is configured to instruct the blower determine an airflow rate into the interior of the cab based at least in part on the restriction factor and a pressure within the interior of the cab and instruct the blower to adjust the airflow based at least in part on the airflow rate.

15. A method for controlling an airflow through an interior of a cab of a work vehicle, comprising:
instructing, via a controller, an airflow control assembly to transition a door of the airflow control assembly to an open position, during an initialization phase, wherein the airflow control assembly is configured to direct an airflow from an external environment into the interior of the cab while the door is in the open position and to recirculate the airflow to the interior of the cab while the door is in the closed position;
instructing, via the controller, a blower to output the airflow, during the initialization phase;
instructing, via the controller, the airflow control assembly to close the door upon detection of a first threshold pressure within the interior of the cab, during the initialization phase;
measuring, via the controller, a depressurization time between the detection of the first threshold pressure and detection of a second threshold pressure within the interior of the cab, less than the first threshold pressure, during the initialization phase;
determining, via the controller, a restriction factor based at least in part on the depressurization time, during the initialization phase;
determining, via the controller, an airflow rate into the interior of the cab based at least in part on the restriction factor and a pressure within the interior of the cab, during an operation phase; and
instructing, via the controller, the blower to adjust the airflow, instructing the airflow control assembly to adjust a position of the door, or a combination thereof, based at least in part on the airflow rate, during the operation phase.

16. The method of claim 15, wherein instructing the blower to adjust the airflow comprises instructing the blower to adjust the airflow until the airflow rate is within a threshold range of a target airflow rate.

17. The method of claim 15, comprising automatically initiating, via the controller, the initialization phase after an initialization reset threshold has elapsed and while doors of the cab and windows of the cab are closed.

18. The method of claim 16, comprising identifying, via the controller, a clogging filter based at least in part on the first signal, the target airflow rate, and the restriction factor.

19. The method of claim 15, comprising identifying, via the controller, a clogged filter by determining if an output voltage of the blower is higher than the expected voltage of the blower by a threshold.

20. The method of claim 19, comprising informing, via a user interface, an operator that the clogged filter is detected.
